(19) United States
(12) Patent Application Publication
(10) Pub. No.: US 2014/0175235 A1
(43) Pub. Date: Jun. 26, 2014

(54) PORTABLE SUPPORT DEVICE FOR ELECTRONIC DEVICES

(71) Applicant: zoomStand, LLC, Phoenix, AZ (US)

(72) Inventors: Christopher BUNCH, Flagstaff, AZ (US); Christopher PIPER, Phoneix, AZ (US)

(73) Assignee: zoomStand, LLC, Phoneix, AZ (US)

(21) Appl. No.: 14/137,375

(22) Filed: Dec. 20, 2013

Related U.S. Application Data
(60) Provisional application No. 61/740,183, filed on Dec. 20, 2012.
(60) Provisional application No. 61/751,172, filed on Jan. 10, 2013.

(51) Int. Cl. F16M 11/04

(52) U.S. Cl. CPC F16M 11/046
USPC 248/157; 248/188.8; 248/165; 248/163.1

(57) ABSTRACT

Devices and methods described herein relate to support stands for supporting electronic devices having a display. The support stand is a modular support stand. The support stand has at least one supporting surface with a releasable interlockable mechanism configured to interlock with other support stand components comprising a releasably interlockable mechanism. The support stand can be configured to connect two supporting surface modules to expand the usable area of the supporting surface, and can also accept module connectors in order to connect other attachments to the supporting surface.

### PRIORITY

This application claims priority to U.S. Provisional Application No. 61/740,183 filed Dec. 20, 2012 and U.S. Provisional Application No. 61/751,172 filed Jan. 10, 2013, both of which are incorporated by reference in their entirety.

### BACKGROUND

Many different attempts have been made to provide structure for supporting laptop computers. Some attempts utilize a rigid platform onto which the laptop rests and implement a softer cushioned component on the platform's underside that is meant to be comfortable against the tops of the user's legs when in a seated position. Other designs utilize a similar rigid platform onto which the laptop rests and employ some type of legs that raise the platform to a height such that the weight of the platform and laptop is supported entirely by the legs.

Such designs generally utilize a large platform of a set size in order to accommodate the most common sizes of laptops. Users with smaller laptops generally use these same laptop stands, resulting in using a laptop stand that is much too big for their laptop. The inverse also commonly occurs, whereas a user with a very large laptop is unable to find a laptop stand that can accommodate the large size of their laptop comfortably. It is also very inconvenient to bring the laptop stand along for travel, as with the large designs of laptop stands packing one into a bag is very impractical. The set size of these configurations also impedes users from easily using peripheral devices, with the most notable example being the lack of space for a mouse pad.

Current designs also restrict laptop stand use to a very limited scope since laptop stands with cushions are only to be used on top of a user's legs when seated, and laptop stands with legs are generally uncomfortable to use atop one's lap. If a user desires to use their laptop in a variety of positions, they must purchase different laptop stands due to the limited usage nature of these designs. Such designs do not offer much flexibility for the user and limit the scenarios where the designs are effective.

Additionally, users of tablet computers face similar problems. Tablet stands tend to be highly situational and body position specific, with many designs working only atop a table or desk, and other designs only being effective atop the user's lap when seated. Furthermore, many tablet stands are not universal, and are instead designed to only accommodate one specific model of a tablet computer.

### SUMMARY

The present disclosure is directed toward an adjustable, compact stand configured to support laptops, computer monitors, tablets, and other electronic devices having a display. The present disclosure includes a system or device comprising a modular surface that is adaptable to suit a variety of sizes of electronic devices conveniently, with the capability of adjusting the supporting surface size to accommodate different sizes of electronic devices without having an undersized or oversized supporting surface to support the device. In addition, the present disclosure includes a system to allow the supporting surface to be used in a variety of configurations through variables such as surface area, surface shape, surface height, and also through modules that can be added to the system in order to tailor the stand to each user's specific needs.

This modular system provides numerous benefits for supporting an electronic device having a display, such as the ability to easily adapt in total overall supporting surface size in order to accommodate a variety of devices, being configurable and customizable for different usages by accepting releasably connectable modules via module connectors, and by having the capability to be quickly and easily broken down into separate pieces for more convenient storage during travel.

Described embodiments have at least one supporting surface member releasably connectable to other supporting surface members. Described supporting surface members are each configured to accept releasably connectable modules. Described embodiments have a working configuration and a space-efficient configuration, where auxiliary modules are stowable on the underside of the supporting surface members. In one embodiment, a plurality of surfaces configured to support a laptop computer could be releasably attached to a module which provides a cushioned surface underneath the supporting surfaces that would be used comfortably atop the user's lap; this module could be later removed and a plurality of modules with adjustable legs could be releasably connected in order to allow the same supporting surfaces to be elevated to a desired height.

One aspect of the disclosure relates to a modular supporting device comprising a first and second supporting members, each having a first surface opposite a second surface and at least one linear side defining a portion of a perimeter; and at least one supporting leg that is pivotably couplable to the second surface of each supporting member wherein each supporting member comprises at least two releasable interlocking mechanisms on the linear side configured to interlock with the at least two releasable interlocking mechanisms on the linear side of the other supporting member such that the first surfaces of the supporting members are coplanar, and wherein the first and second supporting members are decouplable. Another aspect of the disclosure relates to a modular supporting device comprising a supporting member with a first surface opposite a second surface and at least one side defining a periphery, the supporting member comprising at least one first releasable interlocking mechanism located along the periphery and having two accessible ends, one accessible end facing outward and the other facing inward; at least one second releasably interlocking mechanism extending between the first surface and the second surface and having two accessible ends, one accessible end facing upward and the other accessible end facing downward; and at least one supporting leg pivotably couplable to the second surface of the supporting member.

In various embodiments, wherein a device comprises two supporting members, each supporting member can comprise at least two releasable interlocking mechanisms configured to interlock with a releasable interlocking mechanism of a supporting leg, the at least 2 releasable interlocking mechanisms being located at or near the perimeter and positioned relative to each other such that the supporting legs form a support base for at least two interlocked supporting members. In various embodiments, a supporting member can comprise at least one connector module having a depressible locking button and at least one receptacle and a lock-in hole located on at least one surface adjacent each receptacle, both located on the straight side and configured to interlock with the connector module and receptacle on the linear side of the opposite supporting member such that each supporting surface's depressible locking button is adapted to extend through the lock-in hole of the opposite supporting member. In various embodiments, the device can further comprise at least four supporting legs couplable to a connector module at a proximal end, the module having a depressible locking button, wherein the at least two releasable, interlocking mechanisms located at or near the perimeter of each supporting member comprises at least two receptacles and a lock-in hole located on at least one surface adjacent each receptacle, each receptacle being configured to interlock with the connector module couplable to a supporting leg, the connector module having a depressible locking button adapted to extend through the lock-in hole adjacent each receptacle. In various embodiments, the device can further comprise at least one receptacle located on the first surface of each supporting member. In various embodiments, the device can further comprise at least 4 supporting legs. In various embodiments, each supporting leg can be configured to pivotably couple to either the first or second supporting member. In various embodiments, each supporting leg can be length adjustable. In various embodiments, each supporting leg can comprise a telescoping leg. In various embodiments, each supporting leg can comprise a distal end opposite the proximal end of the supporting member and at or near the distal end, each supporting leg can comprise a releasable interlocking mechanism couplable to a telescoping leg extender or a transverse base member. In various embodiments, the releasable interlocking mechanism at the distal end of each supporting leg can comprise a receptacle or a connector module. In various embodiments, the device can further comprise at least one transverse base member, wherein the transverse base member is configured to extend between and releasably couple to two supporting legs. In various embodiments, at least two of the supporting legs are configured to releasably couple to one another at a point along the length of the legs. In various embodiments, the transverse base member is configured to extend between two supporting legs that are not releasably coupled to each other. In various embodiments, the device can further comprise a prop module that is releasably couplable to at least one of the first and second supporting member and may be stowable on the underside of one or more of the supporting members.

The term “coupled” is defined as connected, although not necessarily directly, and not necessarily mechanically. Two items are “couplable” if they can be coupled to each other, and, when coupled, may still be characterized as “couplable.” Unless the context explicitly requires otherwise, items that are couplable are also decouplable, and vice-versa. One non-limiting way in which a first structure is couplable to a second structure is for the first structure to be configured to be coupled (or configured to be couplable) to the second structure. To be “decouplable,” two components are couplable and upon decoupling, are neither directly nor indirectly coupled.

The terms “a” and “an” are defined as one or more unless this disclosure explicitly requires otherwise.

The terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, any of the present devices, systems, and methods that “comprises,” “has,” “includes” or “contains” one or more elements possesses those one or more elements, but is not limited to possessing only those one or more elements. Likewise, an element of a device, system, or method that “comprises,” “has,” “includes” or “contains” one or more features possesses those one or more features, but is not limited to possessing only those one or more features. Additionally, terms such as “first” and “second” are used only to differentiate structures or features, and not to limit the different structures or features to a particular order.

Furthermore, a structure that is capable of performing a function or that is configured in a certain way is capable or configured in at least that way, but may also be capable or configured in ways that are not listed.

The feature or features of one embodiment may be applied to other embodiments, even though not described or illustrated, unless expressly prohibited by this disclosure or the nature of the embodiments.

Any of the present devices, systems, and methods can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure may not be labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 illustrates a top perspective view of a described embodiment having a plurality of connected supporting members having a support surface, with each member being releasably connectable to a plurality of single module connectors having module attachments.

FIG. 2 illustrates a bottom perspective view of components of the supporting surfaces, surface connectors, and module attachments shown in FIG. 1.

FIG. 3 illustrates an exploded top perspective view of components of the supporting surfaces, surface connectors, and module attachments shown in FIG. 1.

FIG. 4 illustrates an exploded bottom perspective view of components of the supporting members, double module connectors, and module attachments shown in FIG. 1.

FIGS. 5a to 5d illustrate various orientations of a modular supporting device comprising supporting members releasably connected to telescoping supporting legs.

FIGS. 6a and 6b illustrate various collapsed configurations of the modular supporting device shown in FIGS. 5a to 5d.

FIG. 7a illustrates an assembled view of the components of the supporting leg adjustment and connecting mechanism.

FIG. 7b illustrates an exploded view of the components of the supporting leg adjustment and connecting mechanism.

FIG. 8 illustrates a top perspective view of another described embodiment having a plurality of connected supporting members having a support surface, with each member being releasably connectable to a plurality of module connectors having module attachments, configured to be used atop a desk or in a seated position, and with optional tablet prop modules attached.

FIG. 9 illustrates a top perspective view of the modular device shown in FIG. 8, configured to be used while standing with leg extensions attached, and with an optional laptop prop module attached.

FIGS. 10a and 10b illustrate top and bottom perspective views of a collapsed configuration of the device shown in FIG. 8.

FIG. 10c illustrates an exploded perspective view of the embodiment shown in FIG. 10b, except, for the purpose of clarity, the transverse leg couplers and auxiliary modules, specifically, the supporting edge module and the prop module, are omitted.

FIG. 11 illustrates an auxiliary module, particularly a prop module, comprising a connecting mechanism.

### DETAILED DESCRIPTION OF THE EMBODIMENTS

Persons skilled in the art will readily appreciate that various aspects of the present disclosure can be realized by any number of methods and apparatuses capable of performing the intended functions. Stated differently, other methods and apparatuses can be incorporated herein to perform the intended functions. It should also be noted that the accompanying drawing figures referred to herein are not all drawn to scale, but can be exaggerated to illustrate various aspects of the present disclosure, and in that regard, the drawing figures should not be construed as limiting.

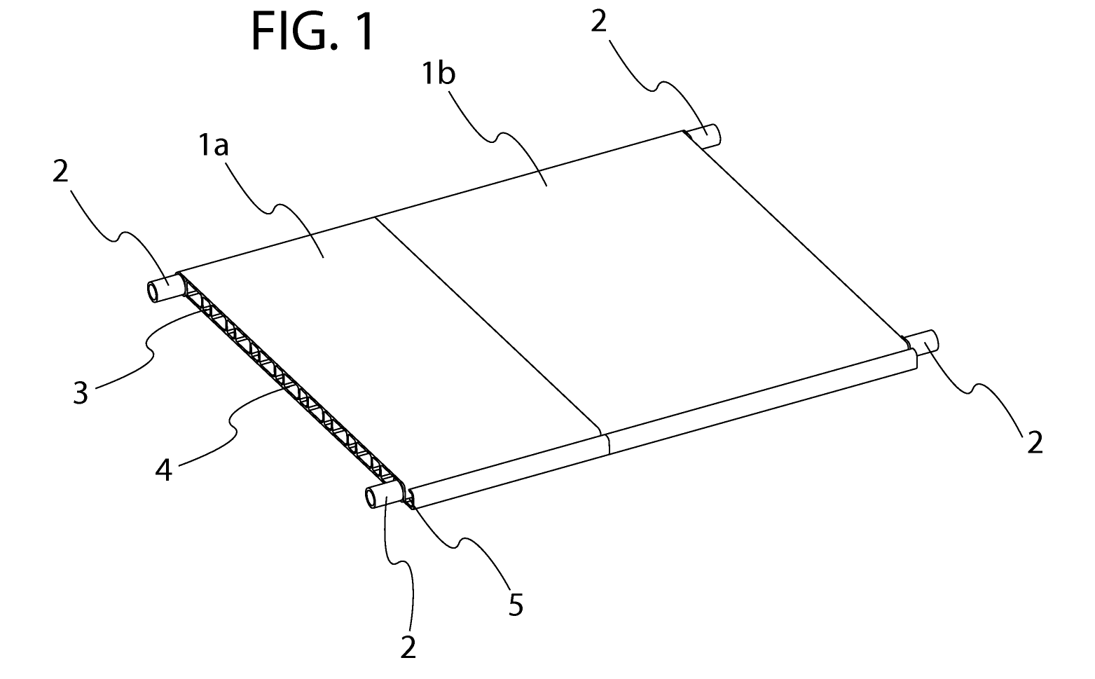

The following description is directed to preferred embodiments of a modular system to support a laptop computer, tablet computer, or other electronic device having a display (collectively a “display device”). Such systems are illustrated in FIGS. 1 and 5a to 5d and 8 to 10b. As shown, a modular system can comprise at least one supporting member 1a or 1b, at least three supporting legs 10, and compatible connecting mechanisms for connecting and disconnecting them to each other. The modular system to support a display device can be configured to adjust the surface area of the supporting surface by increasing or decreasing the number of supporting members. Similarly, the number of supporting legs 10 can also be increased or decreased to accordingly accommodate for an increase or decrease in support surface area.

For example, first supporting member 1a having a surface is adapted to releasably connect to a second supporting member 1b having a surface, thereby increasing the surface area. Supporting members can connect to each other or to other modules along the sides of the members via releasable interlocking mechanisms. Of course, three, four, or more supporting members of various sizes can be connected to increase the surface area to the sum of their surface areas.

The dimension of the supporting member can be any dimension suited for a particular purpose. Dimensions for supporting surfaces for display devices can be adapted to scale according to the relative size of display devices. In various embodiments, the dimensions of a supporting member can be the approximate dimensions of a small tablet or smart phone device. In a further embodiment, the dimension of a second supporting member can be constructed so that the total surface area of the first supporting member plus the second supporting member approximates the dimensions of a standard laptop.

In various embodiments, a releasable interlocking mechanism (also referred to herein as a “connecting mechanism”) can comprise any mechanism suitable to releasably join two modules. For example, a releasable interlocking mechanism can comprise module connectors 2 and receptacles 3 and/or 4. Module connector 2 is adapted to be inserted into receptacle 3 and/or 4 and releasably lock. The modules of the modular system (e.g., supporting members and supporting legs) can have at least one releasable interlocking mechanism, such as one receptacle 3 and/or 4 or module connector 2 in order to connect to other modules. For example, supporting members 1a and 1b can comprise at least two receptacles 3 and/or 4 on a side and at least two receptacles 3 and/or 4 on the opposite side. The receptacles enable a supporting member 1a or 1b to connect to other supporting members 1a or 1b or to other modules, such as supporting legs 10. While embodiments of the present disclosure are described with releasable interlocking mechanisms that comprise module connector 2 and receptacle 3 or 4, any suitable interlocking mechanisms can be used.

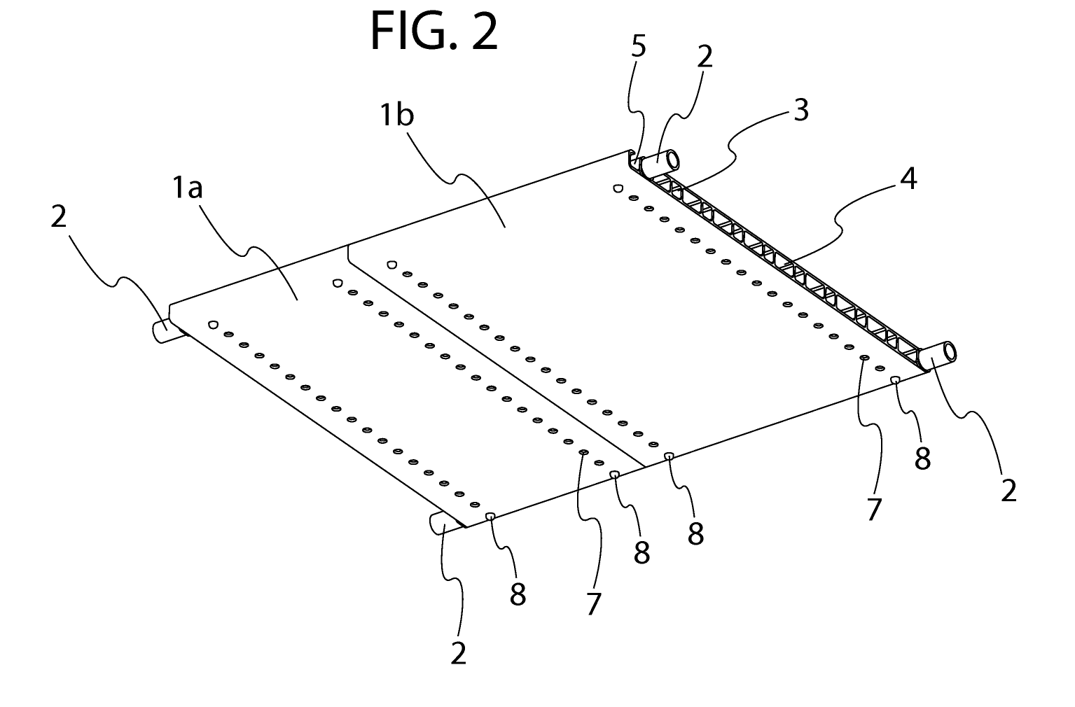

In order to release the modules from each other, a module comprising a receptacle 3 and/or 4 comprises a lock-in hole 7 adjacent receptacle 3 and/or 4 and adapted to interface with depressible locking buttons 8 to facilitate module connectors 2 locking into place. Locking button 8 can then be depressed by the user to unlock and separate the modules. FIG. 2 illustrates the bottom view of the supporting surfaces 1a and 1b with the module connectors 2 connected and a plurality of module lock-in holes 7 with retractable locking buttons 8 extending at least partially through lock-in holes 7. While only one type of connecting mechanism is illustrated, any type of connecting mechanism can be utilized.

Further, an additional open top module connector slot 5 can be provided to facilitate a module 9 or a plurality of modules 9 that could extend along the entire width or length of the supporting surface, either across an intermediate section or along the periphery. For example, a module 9 can comprise a supporting edge that can slideably couple with connector slot 5 and be configured to prevent a device resting on the surface from slipping off the surface in the direction of the supporting edge and/or be configured to provide ergonomic support. Module 9 can be configured to be a cushioned wrist rest, such as for ergonomic support. Alternatively, in lieu of a connector slot 5, the module 9 comprising a supporting edge and/or an ergonomic shape can couple to supporting member 1a and/or 1b via a receptacle and module connector similarly utilized for connecting other modules herein.

Another manner of stabilizing a display device on the supporting member can involve securely coupling the device to an interlocking mechanism. In various embodiments, a display device can be securely couplable to a module which can slideably couple with the connector slot 5 or interlockably couple with a receptacle.

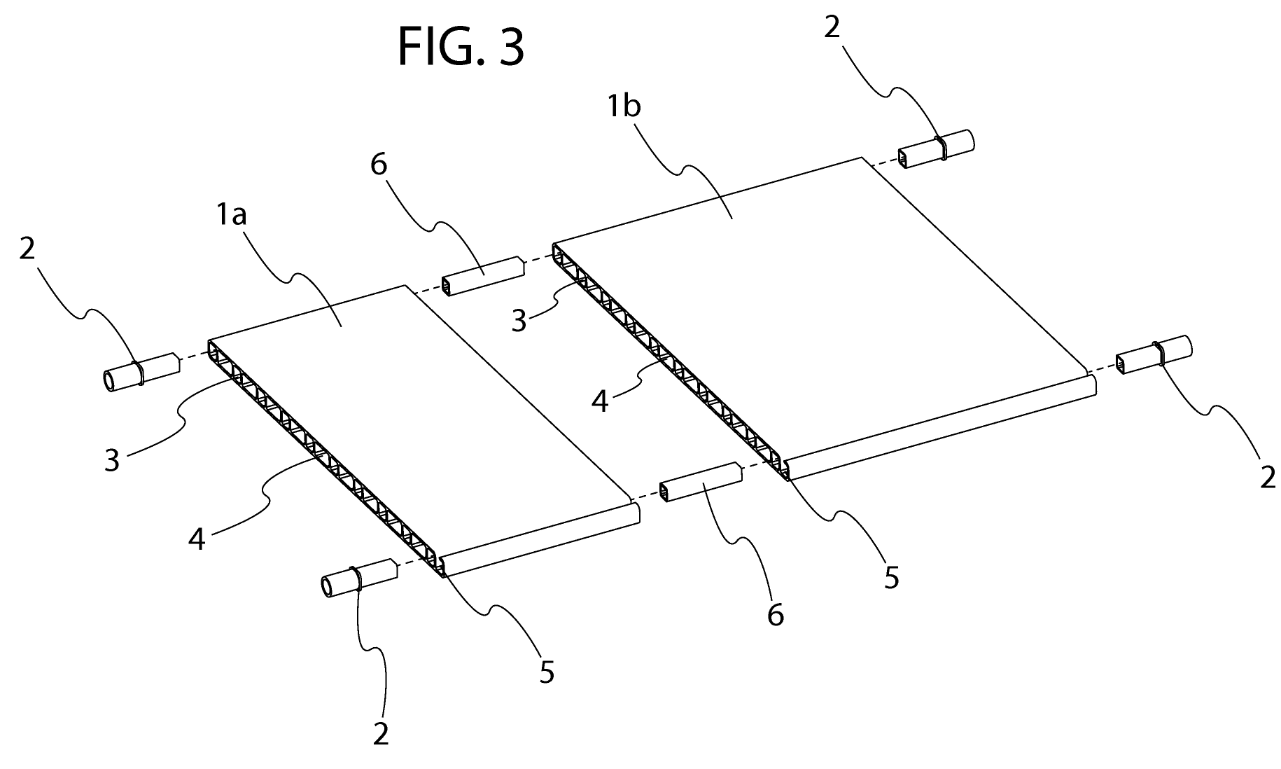

FIG. 3 illustrates an exploded view of the system illustrated in FIG. 1. It depicts how the supporting members 1a and 1b accept a double module connector 6 into each supporting surface's receptacles 3.

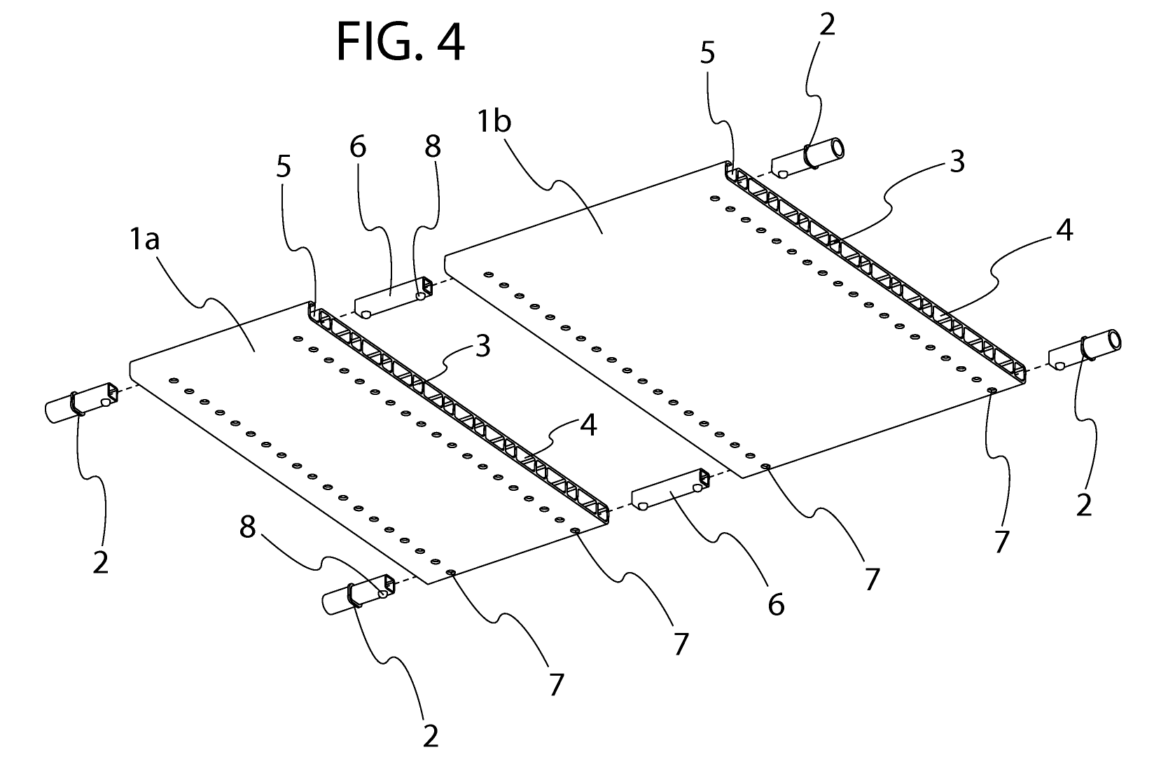

FIG. 4 illustrates an exploded bottom view of the system illustrated in FIG. 1. It depicts the underside of single module connectors 2 and double module connectors 6, and the depressible locking buttons 8 located on each of them. Each depressible locking buttons 8 can be spring-loaded.

Suitable materials for the supporting members and the modules can be any lightweight sturdy material such as a metal (e.g., aluminum, titanium, stainless steel), ceramic, bamboo, hard plastics, wood, carbon fiber composites, or the like. In an embodiment, supporting member 1a or 1b can be extruded aluminum wherein the interstitial spaces within the interior framework can form a receptacle 3 and/or 4. In another embodiment, supporting member 1c can be injection molded using hard plastic. Alternatively, some modules such as a cushioned wrist rest can be any durable material that can be temporarily reshaped with pressure but returns to its initial and intended shape after pressure is released such as rubber, silicon, foam, or the like.

An optional module can comprise a cushioned member (not shown) that could be releasably coupled to supporting members 1a and/or 1b to sit underneath a supporting member and upon a user's lap.

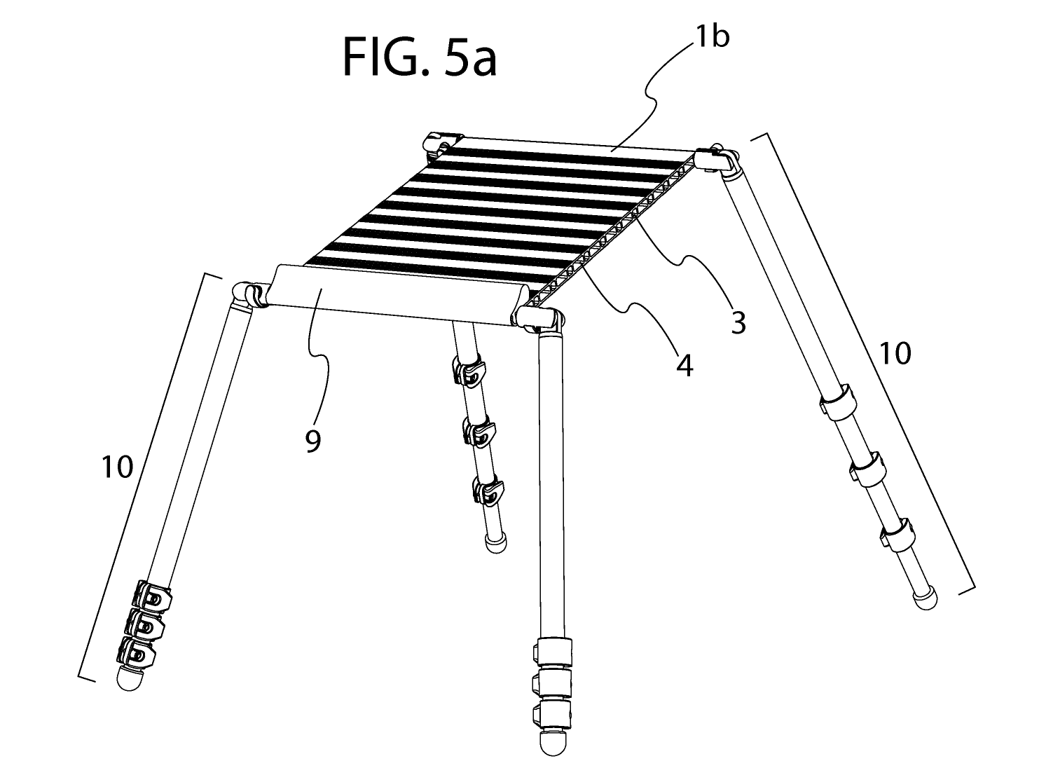

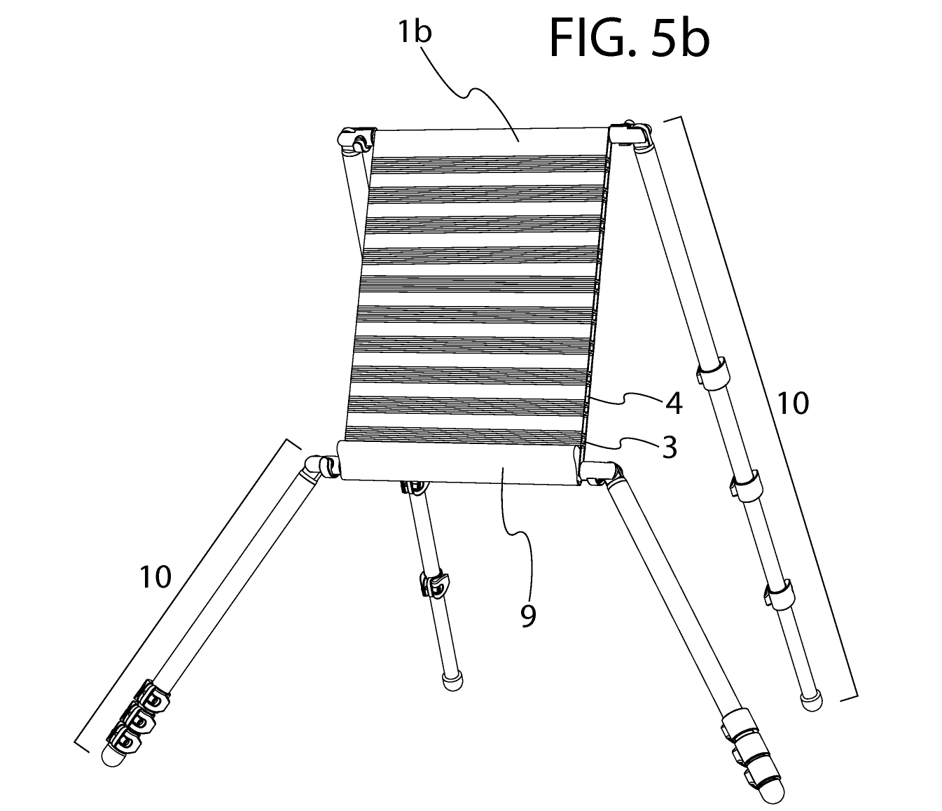

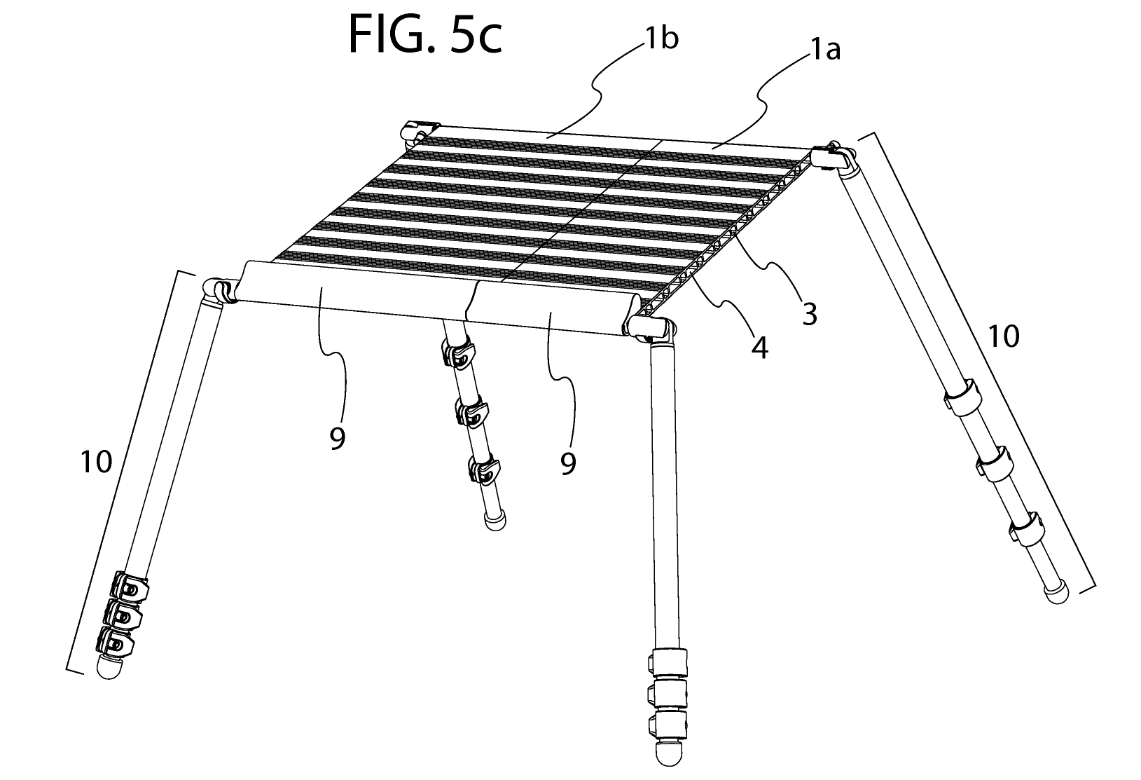

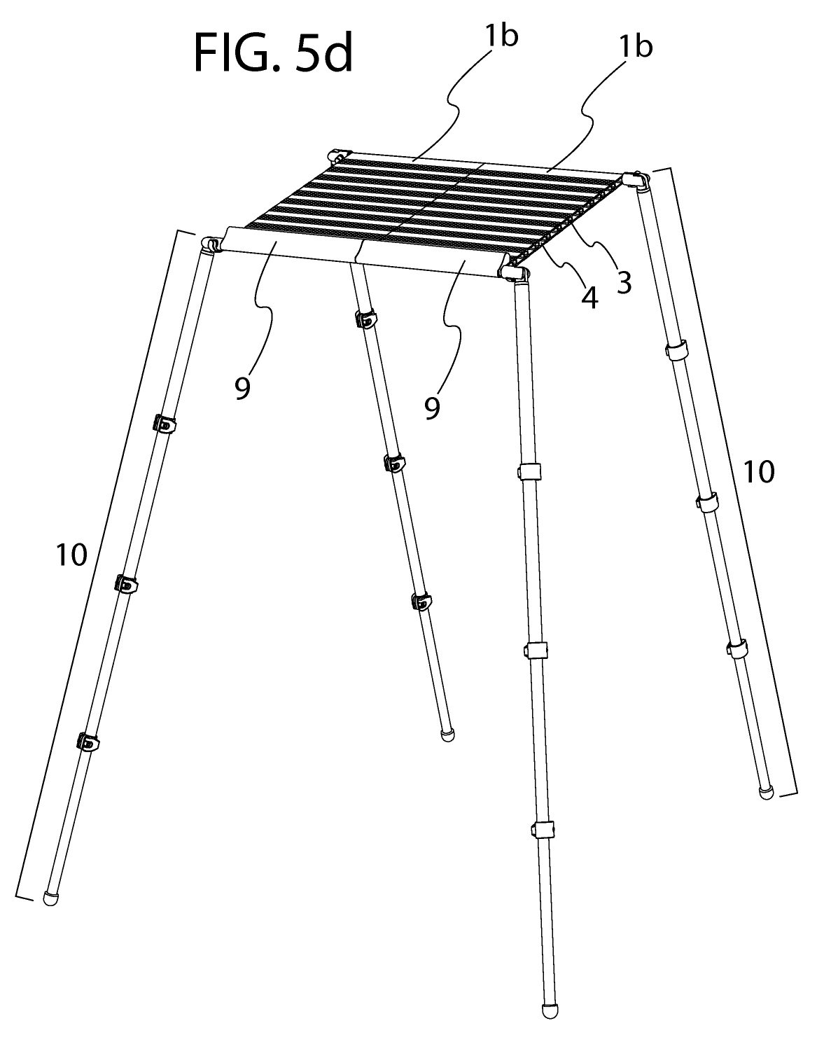

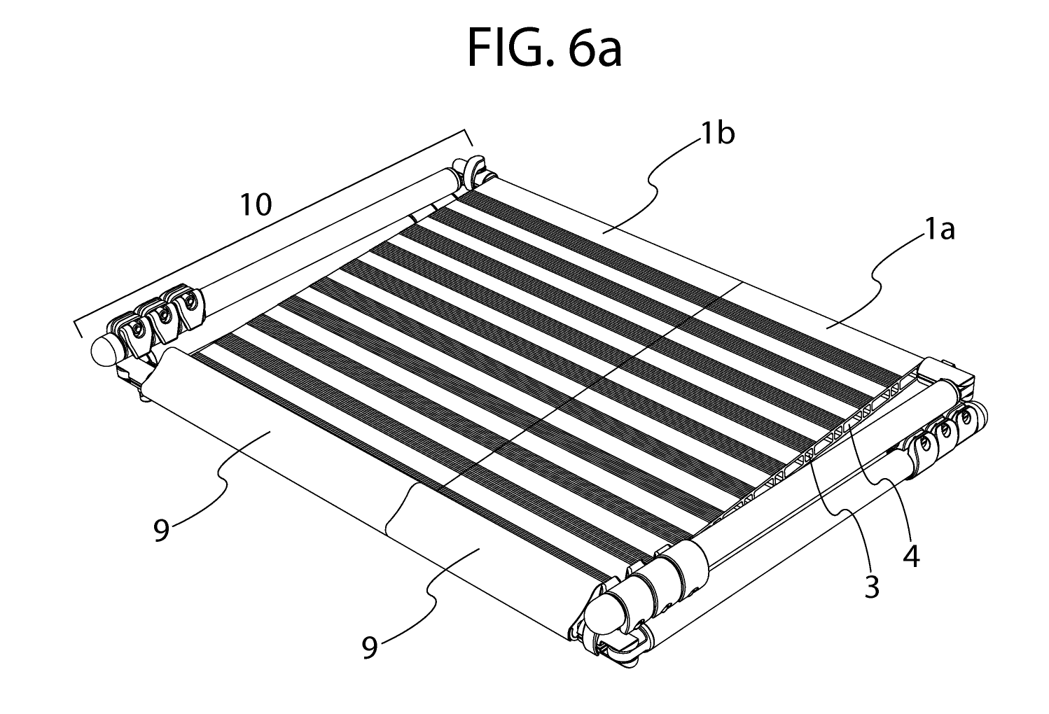

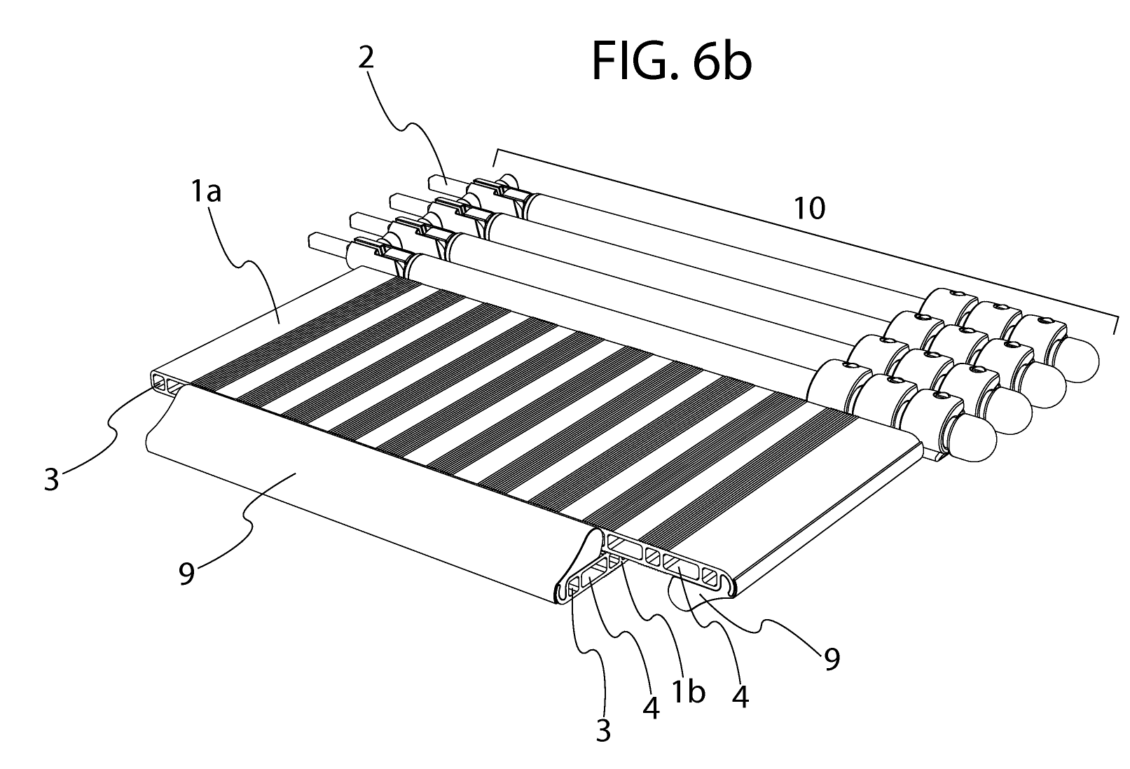

FIGS. 6a and 6b illustrate various collapsed configurations of the modular supporting device shown in FIGS. 5a to 5d. In FIG. 6a, the supporting legs 10 are adjusted to the shortest length and then bent inward adjacent the supporting member 1a and/or 1b. FIG. 6b illustrates another method of collapsing the system whereas the supporting members 1a and/or 1b are separate from one another to facilitate storage in a narrow or fitted bag, and whereas the supporting legs 10 are adjusted to the shortest length with their module connectors 2 disconnected from the supporting members 1a and/or 1b so that the legs 10 may be stored completely separate from the supporting members 1a and/or 1b.

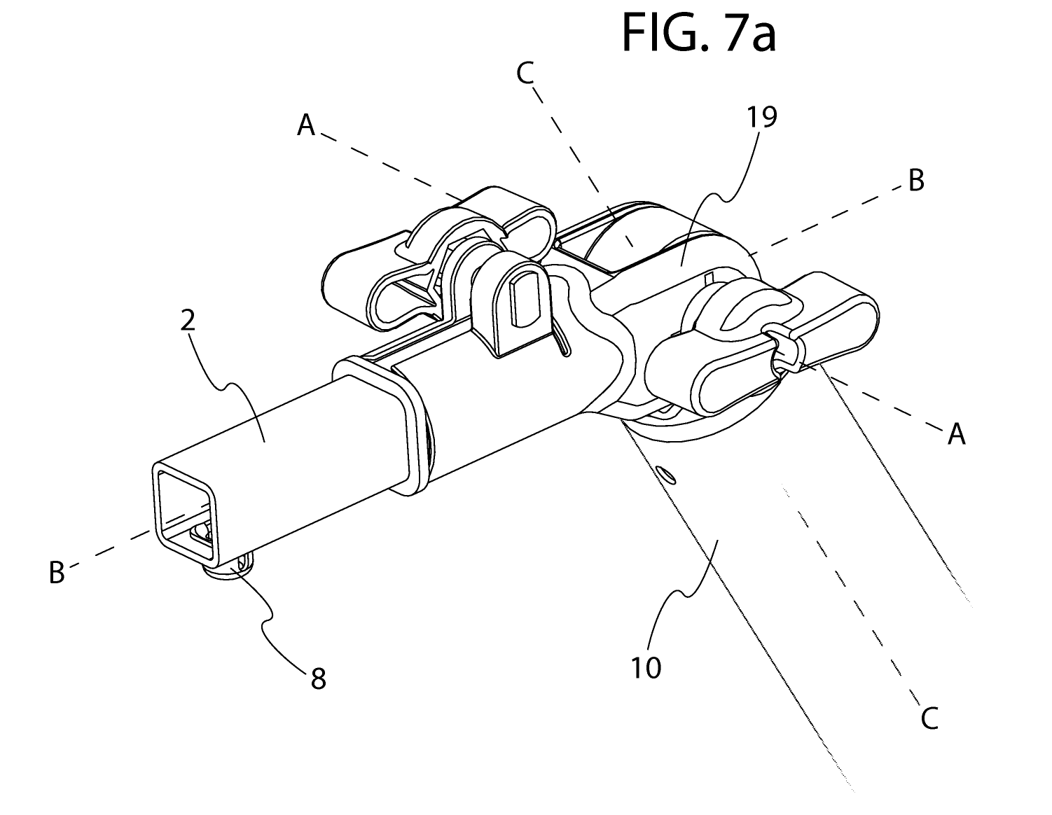

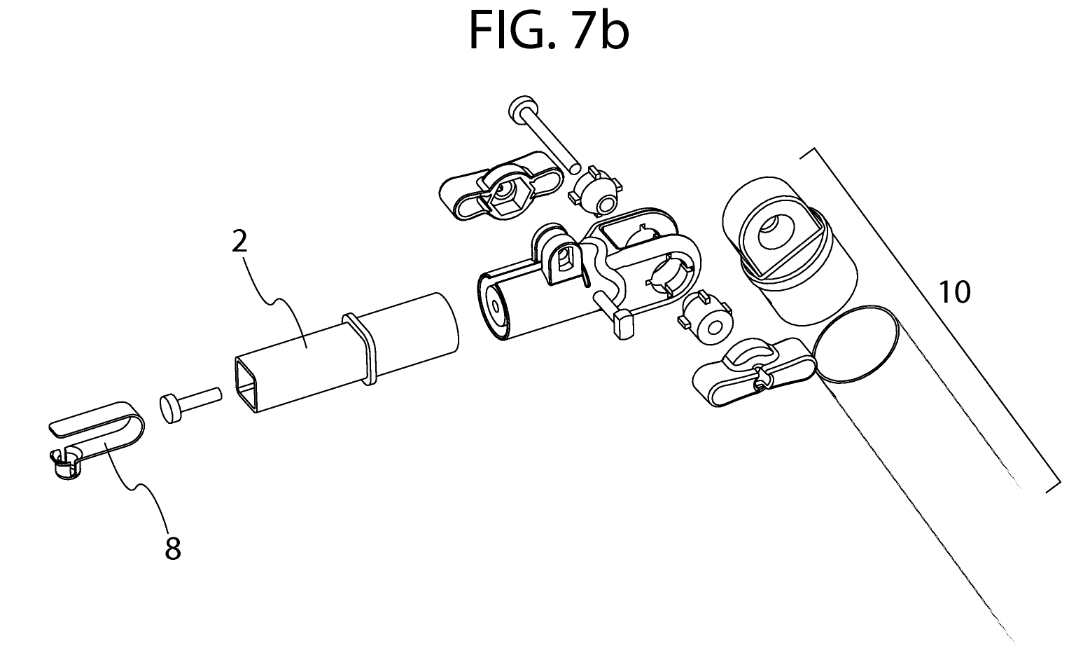

Supporting legs 10 couple to supporting members 1a and/or 1b at a receptacle 3 and/or 4. A module connector 2, pivotably couplable to supporting leg 10, is inserted into the receptacle 3 and/or 4. FIG. 7a illustrates an assembled view of the components of the supporting leg 10 including joint 19 and module connector 2. Joint 19 is configured to rotatably adjust leg 10 about an axis A-A, such that the angle between the longitudinal axis B-B of module connector 2 and the longitudinal axis C-C of supporting leg 10 can be selectively adjusted. Joint 19 as shown is a hinge. However, in other embodiments, joint 19 can comprise a ball-joint. FIG. 7b illustrates an exploded view of the components of the supporting leg 10 comprising the selectively, adjustable hinged joint 19 and module connector 2. The supporting leg 10 can be configured to be pivotably adjusted and securely set at a desired angle relative to module connector 2. Supporting leg 10 can also be configured to be pivotably adjusted and securely set into a desired angle at or near the top of the leg 10.

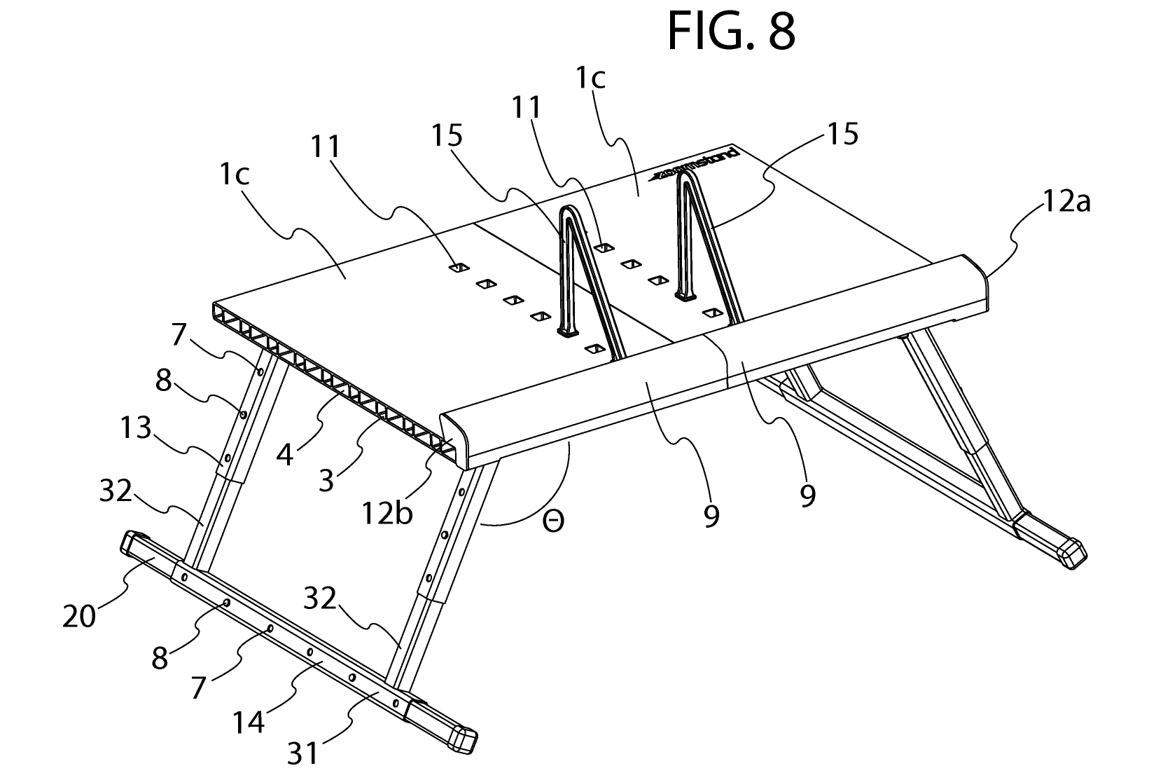

In another embodiment, supporting members can be configured with a modular system of leg attachments. In various embodiments, the modular system of leg attachments can include a leg extension and a transverse leg coupler which can be releasably interlocked with an upper leg portion. For example, with reference to FIGS. 8, 9, 10a to 10c, an upper leg 13 can be configured to be releasably or non-releasably coupled to a supporting member 1c. In addition, the upper leg 13 can be configured to be to be pivotably adjusted relative to supporting member 1c. For example, upper leg 13 can be couplable to supporting member 1c via hinge 19. The angle Θ formed between upper leg 13 and supporting member 1c may or may not be selectively adjustable. The illustrated embodiment shown here utilizes a non-releasable, pivotable connection between upper leg 13 and supporting member 1c. A plurality of legs can be connected to a supporting member 1c in this same fashion.

In various embodiments, upper leg 13 is configured to receive other leg modules as well, such as a transverse leg coupler 14 or a leg extension module 22. Such modules are releasably couplable to upper leg 13 or to each other via interlocking mechanisms which can be configured to allow for length adjustability via a series of lock-in holes 7 that engage with a depressible locking button 8 of the leg modules.

Additionally, multiple supporting members 1c can connect to one another in order to form a single larger surface to support display devices. Supporting members 1c are configured to connect to each other using a connection mechanism that includes a supporting member connecting module 17 and a supporting member connecting receptacle 18. The supporting member connecting module 17 is adapted to be inserted into supporting member connecting receptacle 18 and releasably lock using a locking button 8 that engages with a lock-in hole 7 that is adjacent supporting member connecting receptacle 18.

In various embodiments, transverse leg coupler 14 comprises a transverse member 31 from which two transverse member module connectors 32 are parallel to each other and project from a lateral side of transverse member 31. Both transverse member module connectors 32, each having locking button 8, are configured to couple with upper leg 13 or leg extension module 22. A series of lock-in holes 7 can be configured to provide length adjustability of the supporting leg. In various embodiments, to provide stability to the modular supporting device, transverse member 31 can comprise extendable segments 20 that can project from one or both of the ends of transverse member 31. Extendable segments 20 can be selectively length adjustable. For example, extendable segments 20 can comprise a locking button 8 configured to engage with transverse member 31 at lock-in hole 7 or any one of a series of lock-in holes 7.

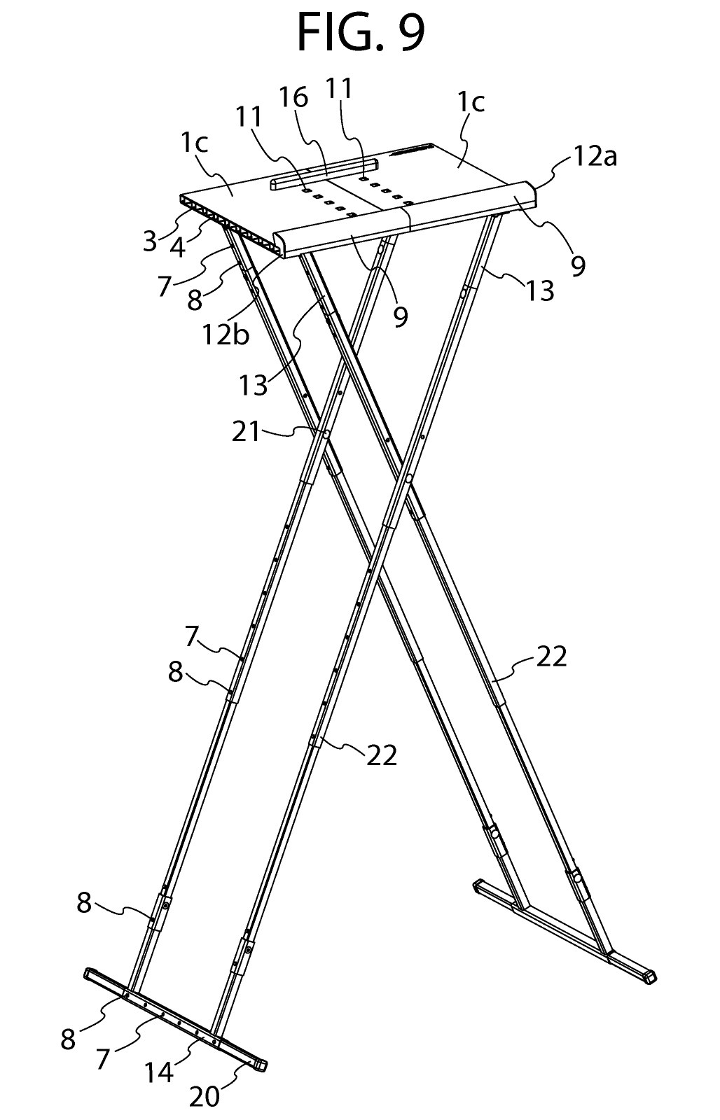

In various embodiments, leg extension module 22 is length adjustable. For example, leg extension module 22 can comprise at least two telescoping members configured to selectively adjust the length, such as via a locking button 8 and a series of lock-in holes 7. The length of the leg extension modules 22 can be adjusted to accommodate the user's preference easily by depressing the locking buttons 8 along the length of the leg extension modules 22 and adjusting which lock-in holes 7 that the locking buttons 8 engage. An optional configuration of the leg extension modules 22, as shown in FIG. 9, can provide for more stability for the entire system due to a triangulation geometry created by the leg extension modules 22 and may be adopted when extra stability is required, such as when a user is using the device while standing, or during other times when the leg extension modules 22 are required. For example, in various embodiments, a releasable leg connector 21 can be configured to releasably connect at least two leg extension modules 22 at one point along each of their lengths along an intermediate section, such that at least two legs form an X-like shape. This configuration creates a triangulation between the supporting member(s) 1c and two supporting legs, each comprising upper leg 13, leg extension module 22, and/or transverse leg coupler 14.

FIG. 8 illustrates one configuration of the modular supporting device, meant to be used primarily when the user is seated. In this configuration, the upper legs 13 can be releasably couplable with the transverse leg couplers 14 via the transverse member module connector 32. The upper legs 13 are rotatable via a hinge 19 from a collapsed or folded configuration, where the upper legs 13 are folded inward and extend alongside the underside of supporting member(s) 1c, to an unfolded configuration, where the upper legs 13 extend in a downward direction relative to the supporting member(s) 1c. In addition, a mechanical stop can limit the outward rotation of the upper leg 13. In various embodiments, the supporting leg comprising the upper legs 13 and transverse leg couplers 14 can be length adjustable. For example, the length can be adjusted to accommodate a user's preference by depressing the locking buttons 8 of the transverse member module connectors 32 and slideably adjusting the module connectors 32 and setting the locking buttons 8 at the desired lock-in hole 7. Additionally, FIG. 8 also illustrates how the topside receptacles 11 are configured to releasably couple the supporting member(s) 1c to other modules, such as prop modules 15. The position of other modules on the supporting member(s) 1c can be selectively adjustably, such as by a plurality of topside receptacles 11. Prop modules 15 can be used to hold an object such as a tablet upright by providing backside support.

FIG. 9 illustrates another configuration of the modular supporting device, meant to be used primarily when the user is standing. In this configuration the upper legs 13 can be releasably couplable to the leg extension modules 22. The leg extension modules 22 can be releasably couplable at their other end with the transverse leg couplers 14 via the transverse member module connectors 32. Additionally, FIG. 9 also illustrates how the topside receptacles 11 are configured to accept a prop module 16. Prop module 16 can be used to lift an object such as a laptop by providing underside support.

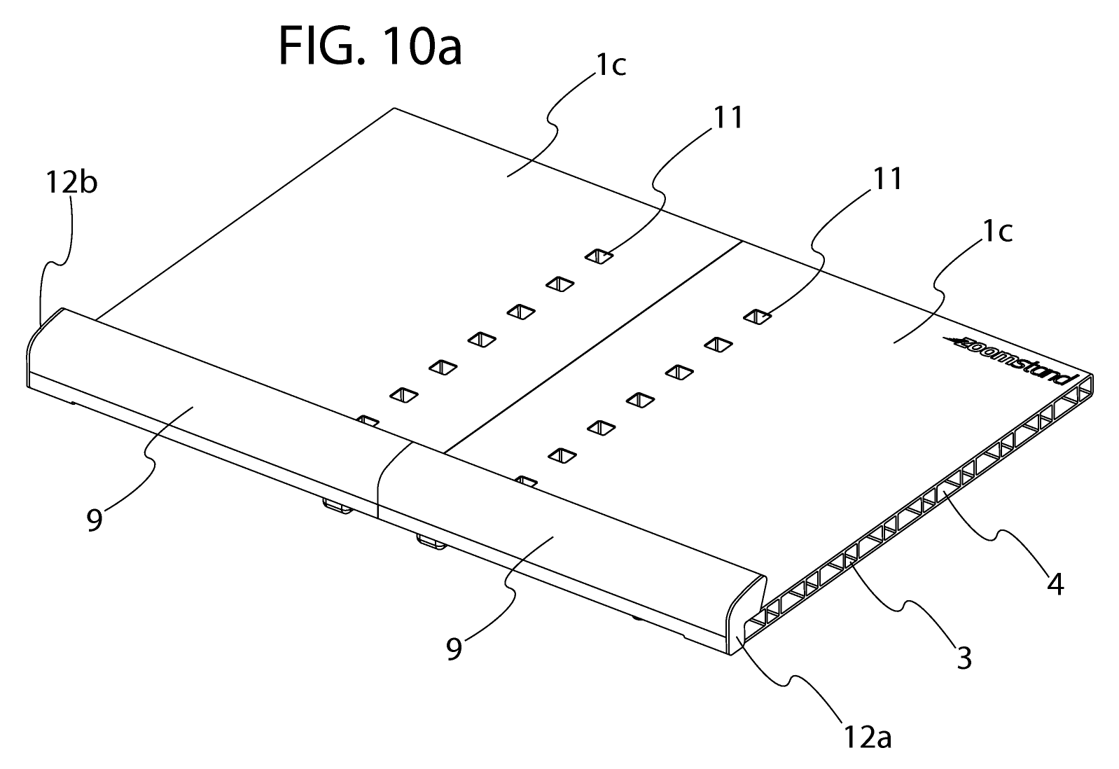

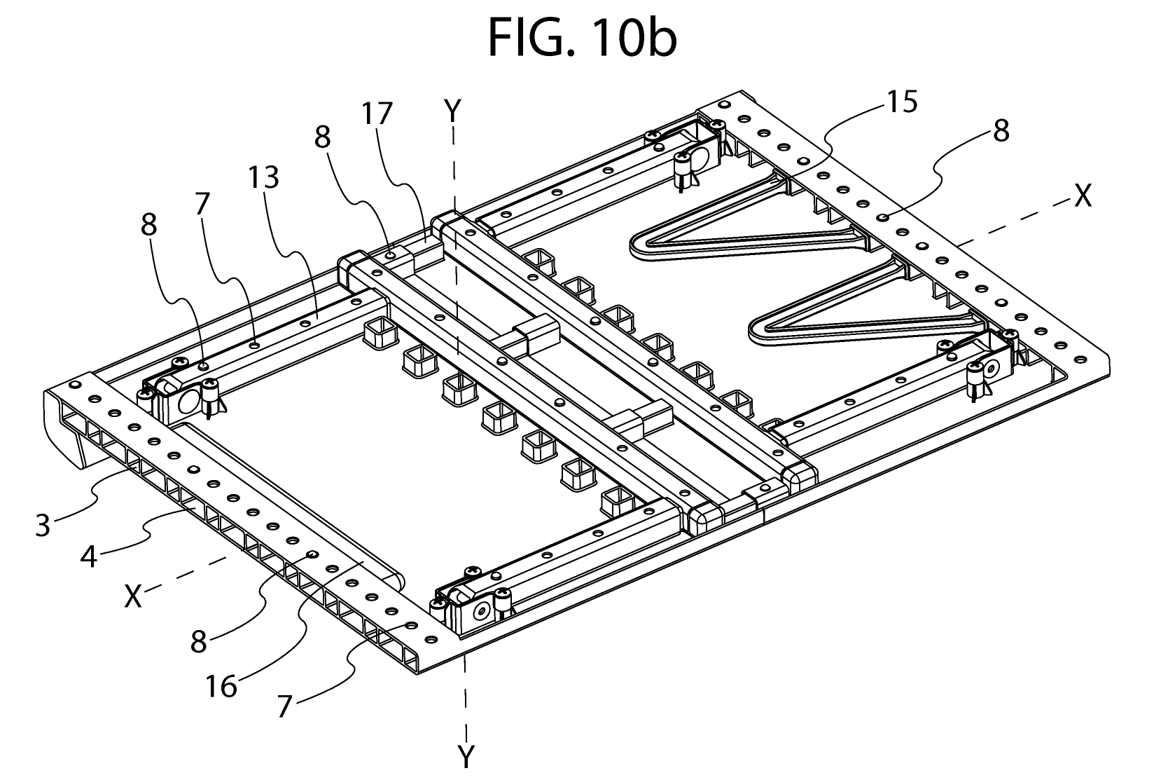

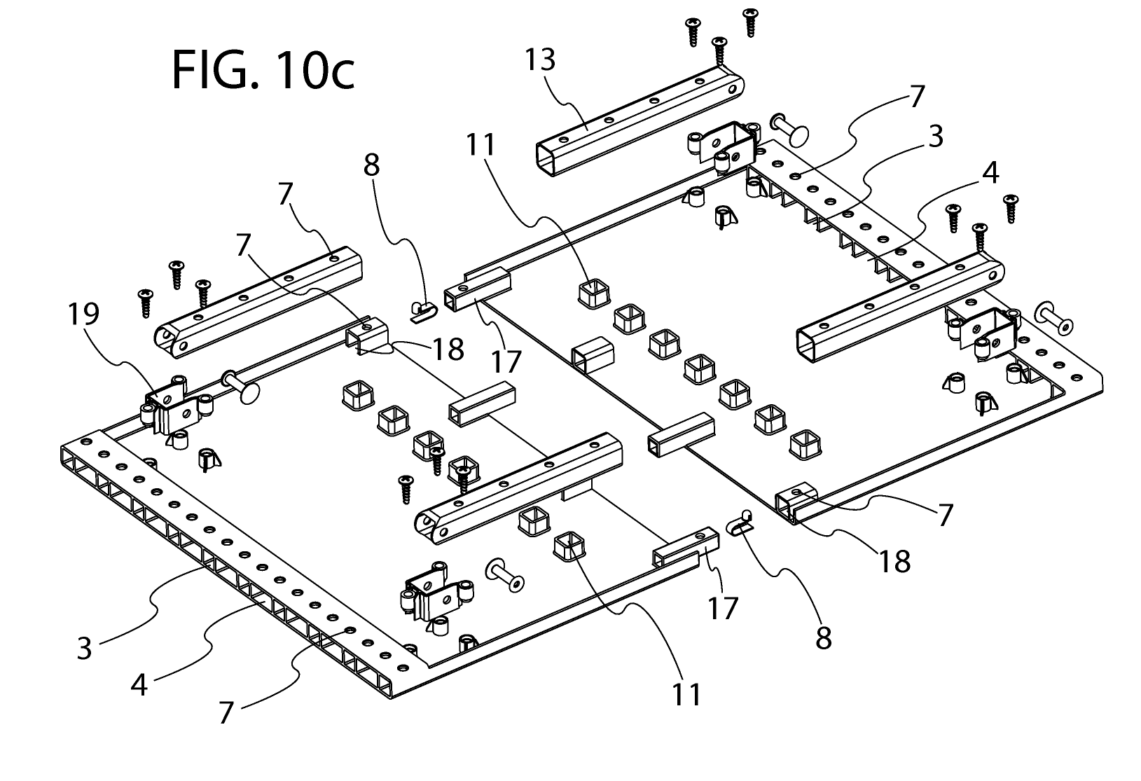

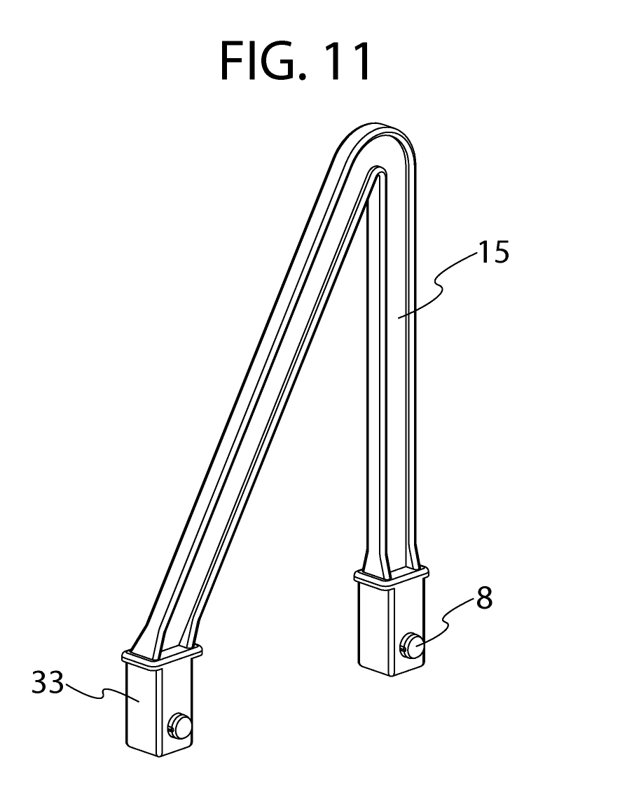

FIGS. 10a and 10b illustrate the collapsed configuration of the modular supporting device shown in FIG. 8. In FIGS. 10a and 10b, the upper legs 13 are releasably couplable with transverse leg couplers 14 via the transverse member module connectors 32 and are shown collapsed to their shortest height. The extendable stability segments 20 are also releasably coupled with the transverse leg couplers 14 and shown collapsed to their shortest length. These adjustments enable the upper legs 13, the transverse leg couplers 14, and the extendable stability segments 20 to all pivot inward about the upper leg connector 19 and nest neatly underneath the supporting member 1c. Additionally, FIG. 10b illustrates how different modules can be stored on the underside of the supporting member 1c when not in use or for storage by being releasably coupled into receptacles 3 accessible on the underside of supporting member 1c. For example, receptacles 3 can be oriented parallel to the surface of the supporting member 1c such that prop module 15 or other modules can be releasably coupled to the supporting surface 1c in a space-efficient manner. In various embodiments, modules can comprise connecting modules comprising locking buttons 8 that engage with supporting member 1c via lock-in holes 7 adjacent a receptacle 3 and/or 4. As shown in FIG. 11, prop module 15 comprises module connector 33 comprising a lock-in button 8. FIG. 10c illustrates an exploded view of the modular supporting device shown in FIG. 10b except, for the purpose of clarity, the transverse leg couplers and auxiliary modules, specifically, the supporting edge module and the prop module, are omitted.

In various embodiments, different receptacles of supporting member 1c can extend in different directions giving a user flexibility in configuration of the modules and/or facilitating a space-efficient configuration. For example, with reference to FIG. 10b, a supporting member 1c can comprise a receptacle on at least two sides of the periphery wherein the axis X-X of the receptacles is parallel with the surface of the supporting member 1c. In addition, supporting member 1c can comprise a receptacle that extends between the top and bottom surfaces thereof along a Y-Y axis which is perpendicular to the surface of the supporting member. In addition, receptacles can be accessed from either end.

To facilitate further adaptability of the device, in various embodiments, the device comprises a generally universal connecting mechanism system such that different types of modules have the same connecting mechanisms and can interlock with any connecting mechanism on supporting member 1c.

The above specification and examples provide a complete description of the structure and use of an exemplary embodiment. Although certain embodiments have been described above with a certain degree of particularity, or with reference to one or more individual embodiments, those skilled in the art could make numerous alterations to the disclosed embodiments without departing from the scope of this invention. As such, the illustrative embodiments of the present modular supporting devices and systems are not intended to be limited to the particular forms disclosed. Rather, they include all modifications and alternatives falling within the scope of the claims, and embodiments other than the one shown may include some or all of the features of the depicted embodiment. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not to be interpreted as including means-plus- or step-plus-function limitations, unless such a limitation is explicitly recited in a given claim using the phrase(s) “means for” or “step for,” respectively.

We claim:

1. A modular supporting device comprising a supporting member with a first surface opposite a second surface and at least one side defining a periphery, the supporting member comprising
at least one first releasable interlocking mechanism located along the periphery and having two accessible ends, one accessible end facing outward and the other facing inward;
at least one second releasably interlocking mechanism extending between the first surface and the second surface and having two accessible ends, one accessible end facing upward and the other accessible end facing downward; and
at least one supporting leg pivotably couplable to the second surface of the supporting member.

2. The device of claim 1, further comprising
a second supporting member with a first surface opposite a second surface and at least two sides defining a periphery,
wherein the first supporting member has at least two sides defining the periphery,
wherein each of the supporting surfaces has at least one linear side defining a portion of the periphery,
wherein each supporting member comprises at least two releasable interlocking mechanisms on the linear side configured to interlock with the at least two releasable interlocking mechanisms on the linear side of the other supporting member such that the first surfaces of the supporting members are coplanar, wherein the first and second supporting members are decouplable.

3. The device of claim 2, wherein each supporting member comprises at least 2 releasable interlocking mechanisms configured to interlock with a releasable interlocking mechanism of a supporting leg, the at least 2 releasable interlocking mechanisms being located at or near the perimeter and positioned relative to each other such that the supporting legs form a support base for at least two interlocked supporting members.

4. The device of claim 2, wherein each supporting member comprises at least 1 connector module having a depressible locking button and at least 1 receptacle and a lock-in hole located on at least one surface adjacent each receptacle, both located on the straight side and configured to interlock with the connector module and receptacle on the linear side of the opposite supporting member such that each supporting surface's depressible locking button is adapted to extend through the lock-in hole of the opposite supporting member.

5. The device of claim 1, further comprising at least four supporting legs couplable to a connector module at a proximal end, the module having a depressible locking button, wherein the at least two releasable, interlocking mechanisms located at or near the periphery of each supporting member comprises at least 2 receptacles and a lock-in hole located on at least 1 surface adjacent each receptacle, each receptacle being configured to interlock with the connector module couplable to a supporting leg, the connector module having a depressible locking button adapted to extend through the lock-in hole adjacent each receptacle.

6. The device of claim 2, further comprising at least two supporting legs pivotably couplable to the second surface of each supporting member.

7. The device of claim 6, wherein each supporting leg is length adjustable.

8. The device of claim 7, wherein each supporting leg comprises a distal end opposite the proximal end of the supporting member and at or near the distal end, each supporting leg comprising a releasable interlocking mechanism couplable to a telescoping leg extender or a transverse base member.

9. The device of claim 8, further comprising at least one transverse base member, wherein the transverse base member is configured to extend between and releasably couple to two supporting legs such that the transverse base member extends along the surface upon which the device is placed.

10. The device of claim 9, wherein the at least one transverse base member comprises at least one extendable segment configured to extend from an end of the transverse base member.

11. The device of claim 9, further comprising at least two leg extenders, each configured to releasably couple to one of the supporting legs to extend the length of each supporting leg, wherein the at least 2 leg extenders are configured to releasably couple to one another at a point along the length of the leg extenders to form an X-like shape.

12. The device of claim 11, wherein the transverse base member is configured to extend between two supporting legs that are not releasably coupled to each other.

13. The device of claim 2, further comprising at least one auxiliary module having a releasable interlocking mechanism that is interlockable with the first releasable interlocking mechanism and the second releasable interlocking mechanism at a different time.

14. The device of claim 13, wherein both the first releasable interlocking mechanism and the second releasable interlocking mechanism comprise a receptacle with a lock-in hole adjacent the receptacle.

15. The device of claim 13, wherein the at least one auxiliary module is a prop module.

16. The device of claim 13 having a collapsed configuration and an unfolded configuration, where, in the collapsed configuration the auxiliary module is stowed on the underside of at least one of the supporting members.

17. The device of claim 2, wherein the supporting member is configured to receive an auxiliary supporting member to thereby increase the area of the combined first and second surface.

18. The device of claim 17, wherein the auxiliary supporting member is configured to be inserted between two supporting members or is configured to extend from the periphery of a supporting member.

19. The device of claim 17, wherein the surface area of the auxiliary supporting member is sized to accommodate a mouse pad.
